(19) United States
(12) Patent Application Publication
(10) Pub. No.: US 2009/0274800 A1
(43) Pub. Date: Nov. 5, 2009

(54) PET FOOD PRODUCT WITH FLAVORING

(75) Inventors: Ute Assenmacher, Baranduda (AU); David Sargeant, Wodonga (AU); Joanna Earnshaw, Albury (AU); Edward Michael McCarron, Albury (AU); Todd Fraser, Kensington (AU)

Correspondence Address: FULBRIGHT & JAWORSKI, LLP, 1301 MCKINNEY, SUITE 5100, HOUSTON, TX, 77010-3095, US

(73) Assignee: MARS INCORPORATED, McLean, VA (US)

(21) Appl. No.: 12/306,131

(22) PCT Filed: Jul. 5, 2007
(86) PCT No.: PCT/AU07/00933

§ 371 Date: Feb. 10, 2009

(30) Foreign Application Priority Data
Jul. 5, 2006 (AU) 2006/03602

(51) Int. Cl. A23L 1/317; B65B 25/06

(52) U.S. Cl. 426/129; 426/302

(57) ABSTRACT

A commercial packeted pet food product, having: an edible substrate, said substrate including at least one surface adapted to receive a suspension of flavorsome materials in a paste, gum or gel; and flavorsome materials, adhering to said surface, which substantially contribute to producing the flavor profile of said pet food product when consumed.

### CROSS-REFERENCE TO RELATED APPLICATIONS

This application is a national stage of PCT/AU2007/000933 filed Jul. 5, 2007 claiming priority to AU 2006903602 filed Jul. 5, 2006.

### TECHNICAL FIELD

The invention relates to the field of commercial pet food manufacture. In particular, the invention relates to a process of efficiently modifying the flavor profile of a commercially mass-produced pet food product with minimal disruption to the manufacturing process.

### BACKGROUND OF THE INVENTION

In the field of commercial pet food manufacture, it is a market expectation, and a practical advantage, to provide a number of flavor profile varieties within food formats sold under any given brand. This provides a dietary variety to the animal and encourages the owner to purchase a range of products from within the brand, rather than spreading their purchases amongst a number of different brands in order to provide the desired dietary variety.

However, a major cost of this practice, in terms of material wastage and factory downtime, arises from the process of stopping the production line following manufacture of a first variety, cleaning down, and restarting the production line on a second variety. This process is necessary to provide a distinction between the varieties and avoid cross-contamination of materials.

This is especially the case for a product which involves any form of extrusion in forming the pet food, since these processes are known to be particularly difficult to start and stop, causing a relatively large amount of wastage of ‘out of spec’ product during the start-up and shut-down procedures.

Accordingly, it is an object of the present invention to provide a product format and manufacturing process for a commercial pet food product, which minimizes the potential downtime involved with changing flavor formulations for same.

### BRIEF SUMMARY OF THE INVENTION

According to one aspect of the invention, there is provided a commercial packeted pet food product, having:
an edible substrate, said substrate including at least one surface adapted to receive a suspension of flavorsome materials in a paste, gum or gel; and
flavorsome materials, adhering to said surface, which substantially contribute to producing the flavor profile of said pet food product when consumed.

Such a product has advantages over the prior art, in that by attaching the main flavorsome materials to the surface of the edible substrate, changing the flavor profile to a different variety, whilst using the same production line, is facilitated because it is only necessary to change the type of flavored materials suspended in the paste, gum or gel. This means that it is not necessary to, for example, halt the production of the substrate and clean the substrate production lines, which tends to be the main cause of production downtime when changing varieties.

One potential embodiment of said substrate is a relatively flat strap of jerky-like material, wherein said surface is the upper surface of said strap. If this type of substrate is desired, it is advantageous to provide an upper surface that includes at least ridges running along the edges of said strap, thereby to form barriers to the runoff of the paste, gum or gel from said upper surface. It may be more preferable to further include a series of corrugations adapted to prevent said paste, gum or gel from spilling off said surface.

Preferably, said base is in the form of an elongate strap, and wherein said upper surface includes at least ridges running along the edges of said strap, thereby to form barriers to the runoff of the gel from said upper surface. Even more advantageously, said base is in the form of an elongate strap, and wherein said upper surface includes a series of corrugations adapted to prevent said gel from spilling off said surface.

These formats for the base provide advantages in that they prevent runoff of the gel from the top surface of the base, with attendant loss of the flavorsome materials. In particular, the corrugation of the upper surface of the base provides barriers to runoff, as well as providing greater surface area to which the materials may adhere.

An alternate embodiment is to provide a substrate which is a tube of jerky-like material, and wherein said surface is the interior surface of said tube.

Preferred formulation for the paste, gum or gel is a combination of modified starch, glycerol, glucose syrup or dextrose monohydrate, food grade oil and an emulsifier. This combination can result in the formation of a gum or gel that is fluid at low temperatures and above 75° C. forms a thermally irreversible gel or gum.

Preferred flavorsome materials include, but are not limited to, natural and nature identical liquid and powder flavors and artificial liquid and powder flavors covering varieties such as beef, liver, chicken, potato, cheese, rice, corn and cranberry.

According to another aspect of the invention, there is provided a method of changing the flavor profile of a commercial packeted pet food, of the type described above, wherein the flavorsome materials alone are substituted for a different set of flavorsome materials.

According to another aspect of the invention, there is provided a method of manufacturing a commercial packeted pet food product, said method including the steps of:
preparing an edible base in the form of an extruded elongate strap or tube according to those described above, having a surface adapted to receive a flavoring material;
preparing one or more flavoring materials, which include flavorsome materials suspended in a paste, gum or gel;
applying said flavoring material or materials to the surface of said edible base adapted to receive said flavoring material to form a relatively even coating;
applying a heat treatment to said base and flavoring material or materials to cause said flavorsome materials to adhere to said base such that the majority of said flavorsome materials remain attached throughout packing and distribution of said pet food.

Preferably, the heat treatment induces drying of the paste, gum or gel.

Now will be described, with reference to various figures, non-limiting, preferred embodiments of the invention.

### BRIEF DESCRIPTION OF THE DRAWINGS

FIG. 1 shows a partly manufactured pet food product according to the invention, wherein a flavorsome topping is shown being applied to an extruded flat jerky-style base, prior to entering an oven.

FIG. 2 shows the extrusion of an alternate flat jerky-style base according to the invention.

FIG. 3 shows the extrusion of another alternate flat jerky-style base according to the invention.

FIG. 4 shows a flat jerky-style product according to the invention.

FIG. 5 shows a representation of a co-extrusion nozzle which may be employed to produce a tubular jerky-style product according to the invention.

FIG. 6 shows a tubular jerky-style product according to the invention.

### DETAILED DESCRIPTION OF THE INVENTION

The invention is effectively the separation of the variety flavor components from the main mass of the pet food into a separate component, thereby allowing the flavor of the pet food to be varied by the relatively simpler variation of the flavor component formulation, while allowing the production of the major portion of the pet food mass to continue unabated.

In the present examples, the commercial packeted pet food product is a meat-based jerky product which has a gel containing flavorsome materials applied to a surface adapted to receive same. The format allows the flavor profile to be changed by substituting a different set of flavorsome materials in the gel-make system, achieving a different flavored variety without stopping the production of the jerky substrate.

### Example 1

In this example, the commercial food product is a meat-based jerky strap, having a coating of flavor materials on an upper surface of the strap.

The edible base is a product of a type commonly known to those skilled in the art, made according to a similar recipe and process as the SCHMACKOS® STRAPZ® PRODUCT marketed by Effem Foods Pty Ltd, of Kelly St, Wodonga VIC 3690.

In particular, the edible base, according to the invention, is produced by comminuting meat and other ingredients, mixing same, extruding onto a moving conveyor a long, relatively flat strap of the mixture, said extrusion being performed through an extrusion nozzle which imparts a cross-sectional shape to the strap.

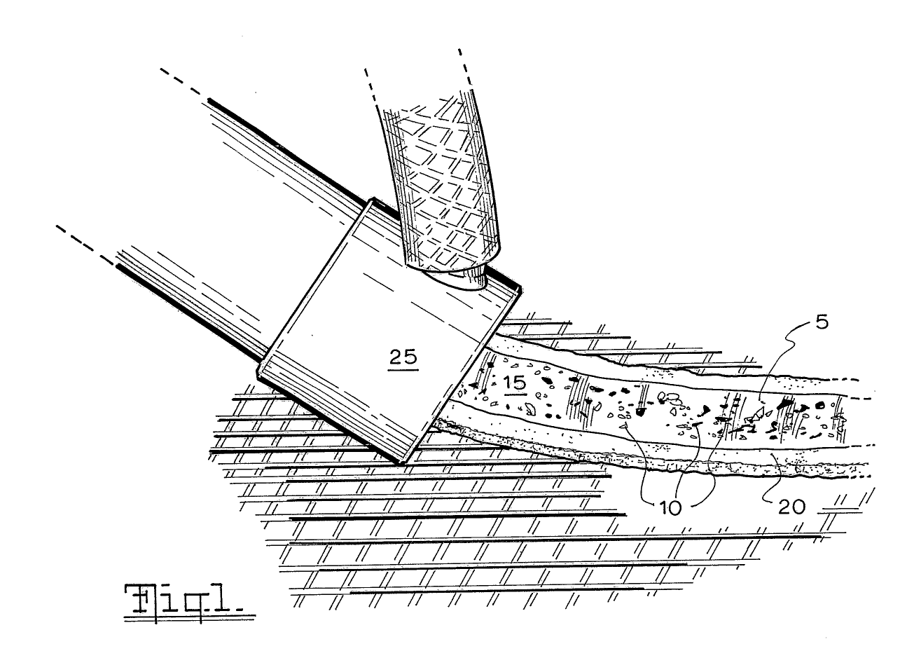

In addition, a flavorsome topping mixture 5, comprising flavor materials 10 suspended in a viscous, fluid gel 15, is prepared in a separate mixing vessel and is applied to the top of the strap 20 as it emerges from the extrusion nozzle 25. This is shown in FIG. 1.

In this particular example, the flavorsome topping mixture is comprised of dried pieces of parsley and capsicum, suspended in a guar gum solution. It will be well understood by those of skill in the art that many other particulates may be used in this way.

The guar gum solution may also optionally contain other particular flavor compounds, such as beef flavoring or smoke flavoring to enhance the flavor profile.

The strap then passes through an oven which cooks the protein and dries the strap to a water activity level which ensures the product is shelf-stable. As the strap bearing the topping then passes through a suitable oven, set at approximately 120-180° C., with a residence time of between 20-60 minutes, the water in the guar solution will be driven off, leaving the materials adhering to the strap by action of the dried guar gum. The oven conditions used will typically depend on the desired production rate. The belt speed will typically be dictated by the pack size. At the slowest running speed the oven temperature ranges from 122-134° C. and the residence time is 50 minutes. At the fastest running speed the oven temperature ranges from 160-170° C. and the residence time is 30 minutes.

The strap is then cut to size and packaged.

A product formed according to the example above is shown in FIG. 4. It features a relatively flat jerky base 26, with dried parsley and capsicum particles 27 adhering to the top surface 28 of the product.

When the desired run of the above described flavor variety has ended, the production of the jerky component may continue unabated. However, as the last batch of the topping material is consumed, a different formulation of topping material, containing dried corn particles and cheese flavoring suspended in a guar gum solution is brought on line, preferably from a separate, parallel mounted topping mix tank.

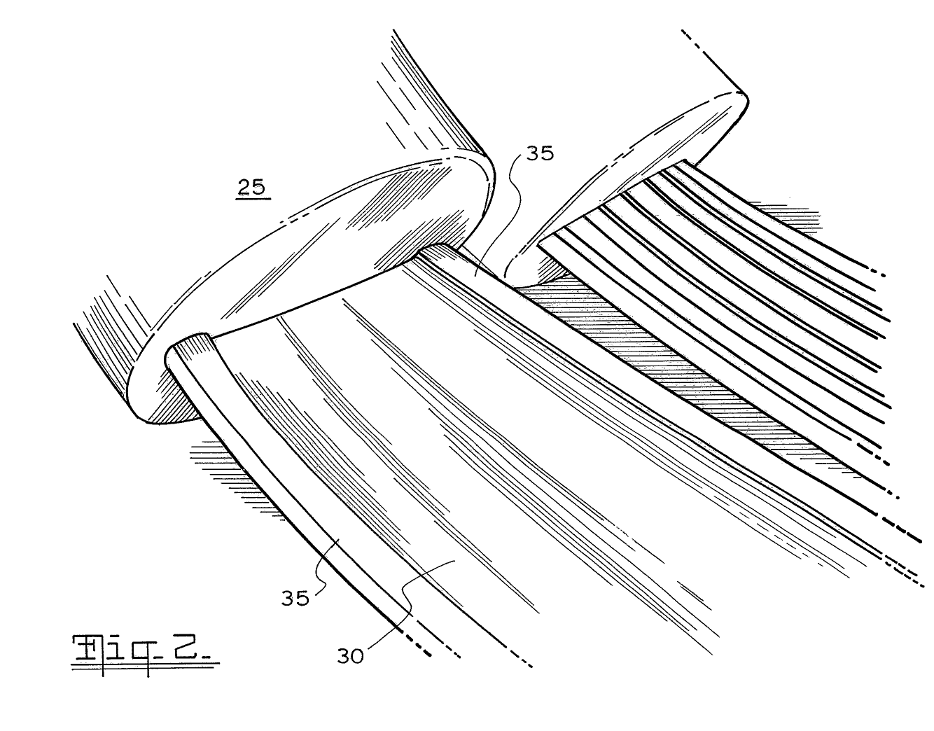

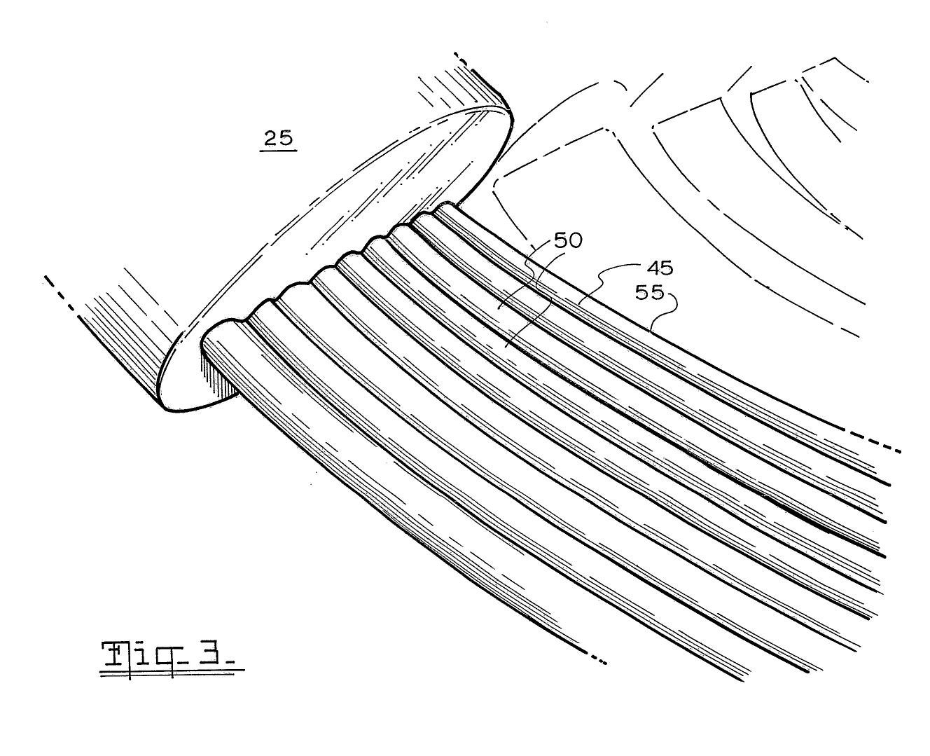

In particularly preferred embodiments, the extrusion nozzle may be shaped to provide an upper surface to the strap which enhances its performance in relation to receiving the topping. For example, FIG. 2 shows an alternate base 30 having raised edges 35, designed to prevent runoff of the topping. FIG. 3 shows another alternate base 45 having corrugations 50 running parallel with the strap edge 55, which prevent runoff, as well as providing greater surface area for the adherence of the flavor particles.

### Example 2

In this example the substrate is a meat-based tubular strap, having a filling of flavorsome materials contained in a gel or gum in the centre of the tubular strap.

The edible base is a product of a type commonly known to those skilled in the art, as per example 1 above.

In particular, the edible base, according to the invention, is produced by comminuting meat and other ingredients, mixing same, co-extruding onto a moving conveyor a long, hollow tube of the mixture, said extrusion being performed through an extrusion nozzle which imparts a tubular, cross-sectional shape to the tube. In addition, a flavorsome mixture, comprising flavor particles suspended in a viscous fluid gel, is prepared in a separate mixing vessel and is co-extruded into the centre of the tube as it emerges from the extrusion nozzle.

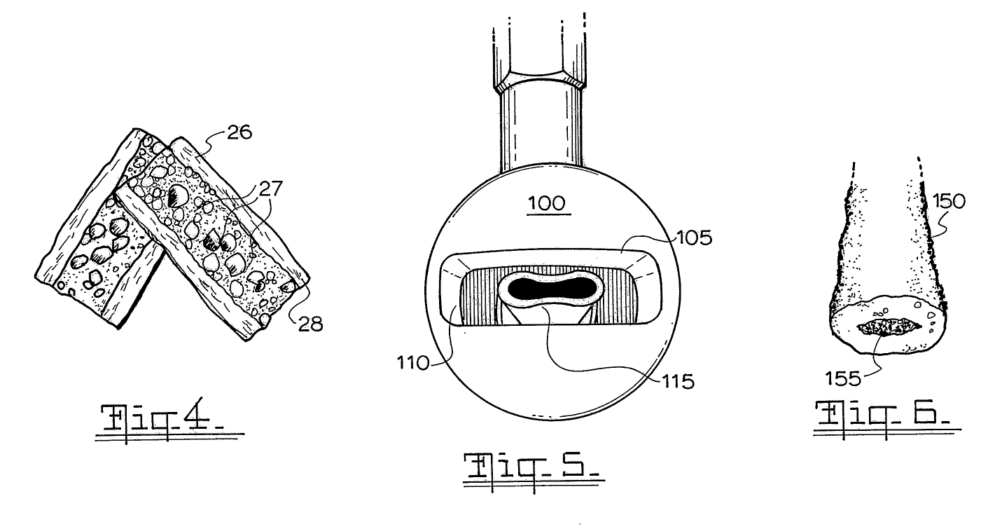

A co-extrusion nozzle suitable for this purpose is shown in FIG. 5. The nozzle has an outer structure 100 having an inner profile 105 which produces an extrusion of the meat jerky material having a profile resembling the inner profile 105. The inner nozzle structure 110 creates a cavity running along the centre of the extruded jerky which is filled simultaneously with a gel bearing flavorsome particles, which emerges from a tube 115 in the inner nozzle structure 110.

The conveyor then causes and allowing the tube to pass through an oven which cooks the protein and dries the filled product to a water activity level which ensures the product is shelf-stable. The product is then cut to size and packaged.

In this particular example, the flavorsome mixture is substantially comprised of powdered, nature-identical roast liver flavor and fried potato flavor suspended in a starch/glucose/oil mixture or a starch/glycerol/oil mixture.

A typical starch/glucose/oil mixture would have a general formulation as follows: modified starch 15-30%, glucose syrup 65-80%, food grade oil 2-10%, emulsifier 0.05-1%, flavors and dyes 1-2%. A typical starch/glycerol/oil mixture would have a general formulation as follows: modified starch 15-30%, glycerol 60-70%, dextrose monohydrate 10-15%, food grade oil 2-10%, emulsifier 0.05-1%, flavors and dyes 1-2%.

The starch/glucose/oil mixture or the starch/glycerol/oil mixture may optionally contain particular flavor compounds, such as beef, vegetable, liver flavoring or smoke flavoring to enhance the flavor profile.

As the tubular jerky containing the flavorsome mixture filling passes through a suitable oven, set at approximately 125-180 ° C. at residence times of between 25 and 50 minutes with desirable results being achieved at the optimal conditions of 170° C. for 30, the filling will tend to set, forming a thermo-irreversible gel.

It may be possible to fill the jerky substrate with more than one flavoring mixture simultaneously. The final product is illustrated in FIG. 6. The tubular jerky product 150 is shown, and the internal ‘filling’ 155 can clearly be seen exposed as being located through the centre of the jerky.

When the desired run of the above described flavor variety has ended, the production of the jerky component may continue unabated. However, as the last batch of the filling material is consumed, a different formulation of filling material, containing different flavors (for example, changing from chicken and liver to chicken and rice) is brought on line, preferably from a separate, parallel mounted filling mix tank.

It will be understood by those of skill in the art that the above are merely two of the ways in which the inventive concept may be embodied. Other embodiments may be conceived of which, while they may depart from the above in some details, nevertheless remain within the spirit and scope of the invention.

1. A commercial packeted pet food product, comprising:
a major portion of an edible substrate substantially comprising a relatively flat strap of reconstituted, comminuted meat jerky-like material including an upper surface adapted to receive a suspension of flavorsome materials suspended in a paste, gum or gel; and
a minor portion of flavorsome non-meat materials, adhering to said surface, which substantially contribute to producing the flavor profile of said pet food product when consumed.

2. The pet food product of claim 1, wherein said upper surface includes at least ridges running along the edges of said strap, thereby to form barriers to the runoff of the paste, gum or gel from said upper surface.

3. The pet food product of claim 1, wherein said jerky-like material is in the form of an elongate strap, and wherein said upper surface includes a series of corrugations adapted to prevent said paste, gum or gel from spilling off said surface.

4. The pet food product of claim 1, wherein said substrate is a tube of jerkylike material and said surface is the interior surface of said tube.

5. The pet food product of claim 1, wherein the paste, gum or gel substantially consists of a mixture of: modified starch; either glucose syrup or a combination of dextrose monohydrate and glycerol, food grade oil and an emulsifier.

6. The pet food product of claim 1, wherein the flavorsome non-meat materials are selected from the group consisting of: artificial, natural and nature identical flavors, including beef, liver, chicken, potato, cheese, rice, corn, cranberry liquid and powder flavors.

7. A method of changing the flavor profile of a commercial packeted pet food product according to claim 1, wherein the flavorsome materials alone are substituted for a different set of flavorsome materials.

8. A method of manufacturing a commercial packeted pet food product, said method comprising the steps of:
preparing an edible base in the form of an extruded elongate strap or tube of communited meat jerky-like material, which comprises a major portion of the food product, wherein the major portion substantially comprises a relatively flat strap of reconstituted, comminuted meat jerky-like material having a surface adapted to receive a flavoring material;
preparing one or more flavoring materials, which include flavorsome non-meat materials suspended in a paste, gum or gel;
applying said flavoring material or materials to the surface of said edible base adapted to receive said flavoring material to form a relatively even coating comprising a minor portion of the food product;
applying a heat treatment to said base and flavoring material or materials to cause said flavorsome materials to adhere to said base such that the majority of said flavorsome materials remain attached throughout packing and distribution of said pet food.

9. The method of claim 8, wherein the heat treatment induces drying of the paste, gum or gel.

10. A method of changing the flavor profile of a commercial packeted pet food product substantially as herein described.

11. A commercial packeted pet food product substantially as herein described with reference to example 1.

12. A commercial packeted pet food product substantially as herein described with reference to example 2.

13. A method of manufacturing a commercial packeted pet food product substantially as herein described with reference to example 1.

14. A method of manufacturing a commercial packeted pet food product substantially as herein described with reference to example 2.
